(19) United States
(12) Patent Application Publication
(10) Pub. No.: US 2023/0154030 A1
(43) Pub. Date: May 18, 2023

(54) OBJECT ORIENTATION ESTIMATION

(71) Applicant: Tobii AB, Danderyd (SE)

(72) Inventors: David Molin, Danderyd (SE); Gerald Bianchi, Danderyd (SE)

(73) Assignee: Tobii AB, Danderyd (SE)

(21) Appl. No.: 17/244,852

(22) Filed: Apr. 29, 2021

Related U.S. Application Data
(60) Provisional application No. 63/017,301, filed on Apr. 29, 2020.

(51) Int. Cl. G06T 7/70

(52) U.S. Cl. CPC G06T 7/70; G06T 2207/20076; G06T 2207/20084

(57) ABSTRACT

The invention is related to a method of estimating an orientation of an object in an image, comprising the steps of: calculating, for the object in the image, a probability distribution of rotation; and estimating the orientation of the object from the calculated probability distribution; wherein the step of calculating the probability distribution and/or the step of estimating the orientation of the object are executed by a neural network; wherein the probability distribution is a matrix Fisher probability density function; and wherein the step of calculating the probability distribution includes approximating a normalizing function for the matrix Fisher probability density function.

### CROSS-REFERENCES TO RELATED APPLICATIONS

The present application claims benefit to provisional patent application U.S. Pat. App. No. 63/017,301, filed Apr. 29, 2020, entitled “3D Orientation Estimation”, and is hereby incorporated by reference in its entirety.

### TECHNICAL FIELD

The present invention relates to the interpretation of images, and more specifically to the estimation of a rotation of an object captured in an image.

### BACKGROUND ART

Estimation of orientation and/or rotation is an important component of several applications, especially where machines must interact with the physical world. This is because physical objects often have a shape and behaviour that is not invariant to their orientations. Specific applications may include the use of orientation estimation to produce a bounding box around a vehicle in the vision of an autonomous vehicle, to assist with maneuvering and object avoidance, or may be applied in the field of robotics to assist the robot with grasping the object correctly. It can also be used in human pose estimation, such as the estimation of rotation of faces, also known as head pose estimation.

Orientation estimation is commonly achieved through the use of image sensors to capture images and identify objects in the images and then the application of a complex mapping to estimate a rotation of specific objects identified. The mapping may be applied to the image through use of a neural networks and/or by the use of Euler angles. This and other such methods of estimation are complicated and time-consuming, or require a large amount of computational power.

Advances of deep learning techniques have resulted in improvements in estimation of 3D orientation. However, precise orientation estimation remains an open problem. The main problem is that the space of all 3D rotations lies on a nonlinear and closed manifold, referred to as the special orthogonal group SO(3). This manifold has a different topology than unconstrained values in ℝ^{N} , where neural network outputs exist. As a result it is hard to design a loss function which is continuous without disconnected local minima. For example using Euler angles as an intermediate step causes problems due to the so-called gimbal lock. Quaternions have a double embedding giving rise to the existence of two disconnected local minima. Some more complicated methods use Gram-Schmidt which has a continuous inverse, but the function is not continuous with a discontinuity when the input vectors do not span ℝ³.

Despite these issues, various deep learning based solutions have been suggested. One approach is to use one of the rotation representations and model the constraint in the loss function or in the network architecture. An alternative is to construct a mapping function that directly converts the network output to a rotation matrix.

Quantifying the 3D orientation uncertainty when dealing with noisy or otherwise difficult inputs is also an important task. Uncertainty estimation provides valuable information about the quality of the prediction during the process of decision making. Only recent efforts have been made on modelling the uncertainty of 3D rotation estimation. However, these methods still rely on complex solutions to fulfil the constraints required by their parameterization.

It is therefore desirable to provide an alternative method of orientation estimation.

### STATEMENTS OF INVENTION

According to a first aspect, there is provided a method of estimating an orientation of an object in an image, comprising the steps of:
calculating, for the object in the image, a probability distribution of rotation; and
estimating the orientation of the object from the calculated probability distribution;
wherein the step of calculating the probability distribution and/or the step of estimating the orientation of the object are executed by a neural network;
wherein the probability distribution is a matrix Fisher probability density function; and wherein the step of calculating the probability distribution includes approximating a normalizing function for the matrix Fisher probability density function.

The matrix Fisher probability density function is advantageous as its parameterization is unconstrained, so there is no need for complex functions to enforce constraints. Moreover, it is possible to create a loss for this distribution that has desirable properties such as convexity. In addition, the mode of the distribution can be subsequently estimated along with the uncertainty around that mode, which enables further analysis.

The probability distribution may be estimated about a plurality of axes. The rotation or orientation estimated about each of the plurality of axes may be estimated jointly.

The matrix Fisher distribution may be defined as:

$$p \left(R \left|F\right)\right) = \frac{1}{a \left(F\right)} exp \left(t r \left({F}^{T} R\right)\right) .$$

The normalizing function may be defined as:

$$a \left(F\right) = {\int }_{R ∈ S O \left(3\right)} exp \left(t r \left({F}^{T} R\right)\right) d R .$$

According to a second aspect, there is provided a non-transitory computer-readable storage medium having stored thereon computer-readable instructions that, when executed by a computer, cause the computer to execute a method of estimating an orientation of an object in an image, the method comprising the steps of:
calculating, for the object in the image, a probability distribution of rotation; and
estimating the orientation of the object from the calculated probability distribution;
wherein the step of calculating the probability distribution and/or the step of estimating the orientation of the object are executed by a neural network;
wherein the probability distribution is a matrix Fisher probability density function; and wherein the step of calculating the probability distribution includes approximating a normalizing function for the matrix Fisher probability density function.

The probability distribution may be estimated about a plurality of axes. The rotation or orientation estimated about each of the plurality of axes may be estimated jointly.

The matrix Fisher distribution may be defined as:

$$p \left(R \left|F\right)\right) = \frac{1}{a \left(F\right)} exp \left(t r \left({F}^{T} R\right)\right) .$$

The normalizing function may be defined as:

$$a \left(F\right) = {\int }_{R ∈ S O \left(3\right)} exp \left(t r \left({F}^{T} R\right)\right) d R .$$

### BRIEF DESCRIPTION OF THE DRAWINGS

Specific embodiments will now be described in detail with reference to the accompanying drawings, in which:

FIG. 1 is a visualisation of the matrix Fisher distribution on SO(3);

FIG. 2 is a visualisation of the matrix Fisher distribution for simple F matrices;

FIG. 3 is the depiction of qualitative results of the present invention on Pascal3D+ images; and

FIG. 4 is the depiction of the estimated probability density function during training for a rotationally symmetric object.

### DETAILED DESCRIPTION

The present invention is operable by the use of a probability distribution over a set of 3D rotation matrices. A neural network or other optimisation process can then be used to output parameters of the probability distribution and the estimate of orientation can be based on the most likely orientation around a number of different axes, as defined by the probability distribution. The loss can then be derived, based on maximising the likelihood of the labelled data.

### Defining the Probability Density Function

In one embodiment, the probability distribution is a matrix Fisher distribution. This distribution has the probability density function:

$$p \left(R \left|F\right)\right) = \frac{1}{a \left(F\right)} = exp \left(t r \left({F}^{T} R\right)\right)$$

where F is an unconstrained matrix in ℝ^{3×3} parameterising the distribution, and R ∈ SO(3) and a(F) is the distribution’s normalizing constant. R is distributed according to a matrix Fisher distribution with R~M(F) .

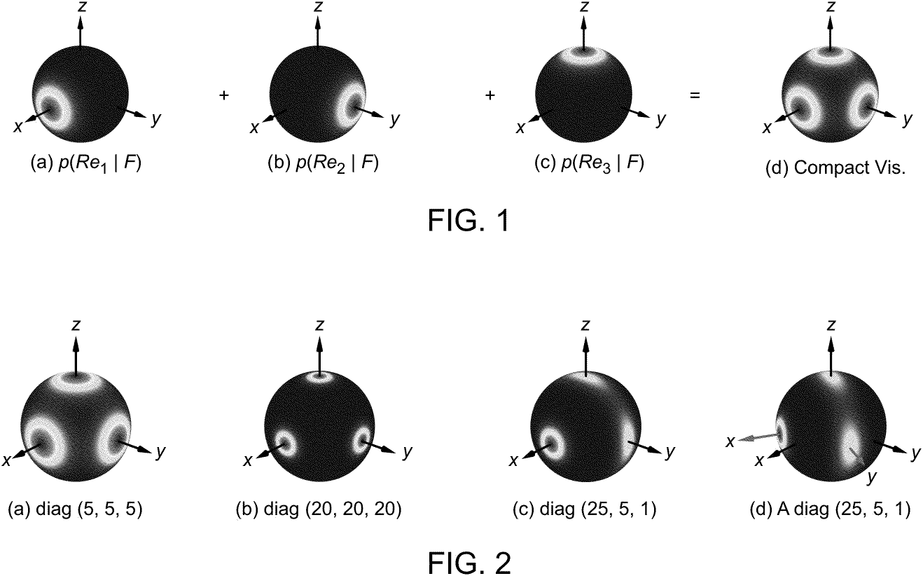

FIG. 1 shows a visualization of the matrix Fisher distribution on SO(3), where SO(3) is a set of 3D rotations.

The plots of FIG. 1 visualise the distribution where the parameter matrix is F = diag(5,5,5). Let e₁, e₂, and e₃ correspond to the standard basis of IR³and is shown by the black axes. Plot (a) shows the probability distribution of Re₁ when R∼M(F) . Thus, the probability density function shown on the sphere corresponds to the probability of. where the x-axis will be transformed to after applying R∼M(F). Plots (b) and (c) show the same as plot (a) but considering e₂ and e₃ in place of e₁. Plot (d) is a compact visualisation of the three marginal distributions shown in plots (a), (b), and (c), displayed on the same 3D sphere with the same scale.

From Igor Gilitschenski et al (Deep orientation uncertainty learning based on a bingham loss. In International Conference on Learning Representations, 2019), we know that the mode of the distribution can be computed from the singular value decomposition of F = USV^{T} where the singular values are sorted in descending order, and setting:

$$\hat{R} = \left(\begin{matrix}1 & 0 & 0 \\ 0 & 1 & 0 \\ 0 & 0 & \text{det} \left(U V\right)\end{matrix}\right) {V}^{T}$$

The latter operation ensures has determinant 1 and is orthonormal. FIG. 2 displays examples of the distribution for simple F matrices. These Figures show that larger singular values correspond to more peaked distributions.

Plot (a) shows that, for spherical F, the mode of the distribution is the identity. The distribution for each axis circular and identical. In plot (b), the axis distributions are more peaked than in (a) as the singular values are larger. In plot (c), the distribution for the y- and z-axes are more elongated than for the x-axis as the first singular value dominates. Shown in plot (d), A is the rotation matrix obtained by rotating around the z-axis by -n/6 degrees and thus the mode rotation is A shown by the red axes. The shape of the axes distribution, though, remains the same as in plot (c).

The normalizing function, a(F) is:

$$a \left(F\right) = {\int }_{R ∈ S O \left(3\right)} \text{exp} \left(t r \left({F}^{T} R\right)\right) d R$$

Equation (3) can be computed by doing an integral over Bessel functions, see Taeyoung Lee (Bayesian attitude estimation with the matrix fisher distribution on so (3). IEEE Transactions on Automatic Control, 63(10):3377-3392, 2018).

The normalizing constant can be expressed as a generalized hypergeometric function of matrix arguments. This can be defined recursively by integrals over positive definite matrices. Similar to the standard generalized hypergeometric function it has a combinatorial definition, which is:

$${}_{1} {F}_{1}^{\left(2\right)} \left(\frac{1}{2} , 2 , X\right) {\sum }_{k = 0}^{∞} {\sum }_{\left(k\right| - k} \frac{\left(\frac{1}{2}\right) {k}^{\left(2\right)}}{k ! {\left(2\right)}_{k}^{\left(2\right)}} {C}_{k}^{\left(2\right)} \left(X\right)$$

The normalizing constant can also be expressed as a one dimensional integral over Bessel functions as described by the equation (14) and (15) in Taeyoung Lee (Bayesian attitude estimation with the matrix fisher distribution on so (3). IEEE Transactions on Automatic Control, 63(10):3377-3392, 2018). This integral is approximated by using the trapezoid rule. In the approximation for experiments we used 511 trapezoids. Standard polynomials were used to approximate the Bessel function using Horner’s method. Trapezoid integrals and parallel evaluations of Horner’s method are simple to implement in a vectorized manner using for example numpy or pytorch, in the latter case to potentially run on a GPU. The present implementation of this approximation has a negligible computational cost compared to the forward and backward pass of a neural network.

To ensure correctness it was checked that the analytical and numerical gradients of the functions were similar, and the implementation was compared with Koev’s implementation (Plamen Koev and Alan Edelman. The efficient evaluation of the hypergeometric function of a matrix argument. Mathematics of Computation, 75(254):833-846, 2006) to check that the two implementations were consistent.

To approximate the correctness the same implementation was used (i.e. trapezoid integrals of Bessel functions) with 2¹⁴ - 1 trapezoids in float 128 precision in place of the “true function”. The only source of errors which is known to remain is the approximation of the Bessel function, but here we use a standard method which should have a very high accuracy.

The function of the present invention was evaluated on 1000 randomly sampled points with singular values less than 50, with a 50% chance of setting the smallest eigenvalue to be negative.

It is believed that this should cover the values to be encountered during training and there should not be any issues with using this method for larger singular values.

For these experiments, the accuracy of the forward pass was evaluated by evaluating |log(a(S)) - f (S)| where f is the approximation of log(a(S)) . The accuracy of the backward pass was evaluated by evaluating ||∇ₛ log(a(S)) - g(S)|| where g is the approximation of ∇ₛ log(a(S)) and ||·||₂ is the vector 2 norm.

The maximum error encountered in the forward pass was 4.6*10⁻³. The mean error of the forward pass was less than 1.2*10⁻³. The maximum error for the backward pass was less than 3.4*10⁻³. The mean error for the backward pass was less than 6.9*10⁻⁴.

### Loss Function

Assume we have a labelled training example (x, Rₓ) where x is the input and is Rₓ ∈ SO(3) its ground truth 3D rotation matrix. To train a neural network that estimates Fₓ for input x, it is necessary to define a loss function measuring the compatibility between Fₓ and Rₓ. As the probability density function in equation (1) has support in all of SO(3), we use the negative log-likelihood of Rₓ given Fₓ as the loss:

$$L \left({F}_{x} , {R}_{x}\right) = - \text{log} \left(p \left({R}_{x} \left|{F}_{x}\right)\right)\right) = \text{log} \left(a \left({F}_{x}\right)\right) - t r \left({F}_{x}^{T} {R}_{x}\right)$$

This loss has several interesting properties, such as it is Lipschitz continuous, convex, and has Lipschitz continuous gradients, which makes it suitable for optimization.

In practice, the loss in equation (5) has an equilibrium far from the origin. In some embodiments it is therefore desirable to use a regularizing term that is larger than is analytically correct to move the equilibrium closer to the origin. In some embodiments this regularizing term may be 2.5% larger than what is analytically correct.

### EXPERIMENTAL DETAILS

This approach was tested on three separate datasets: Pascal3D+, ModelNeet10-SO(3), and UPNA head pose. For each dataset, some pre-processing was required to prepare it before training. Afterwards, the results could be evaluated.

### Datasets and Pre-Processing

Pascal3D+ has 12 rigid object classes and contains images from Pascal VOC and ImageNet of these classes. Each image is annotated with the object’s class, bounding box and 3D pose. The latter is found by having an annotator align a 3D CAD model to the object in the image.

In a pre-processing stage, each image has a homography applied so that the transformed image appears to come from a camera with known intrinsics and a principal axis pointing towards the object. In order to avoid cropping changing the orientation of the image, an image cropped by use of a bounding box is warped in order to provide the correct ground truth orientation data.

This is achieved by assuming that the position of the bounding box used for cropping is known and a desired pinhole camera is created, which is rotated relative to the real camera in such a way that the principal axis is facing the center of the bounding box. We let the intrinsic of the desired camera be:

$${I}_{i d e a l} = \left(\begin{matrix}f & 0 & s / 2 \\ 0 & f & s / 2 \\ 0 & 0 & 1\end{matrix}\right)$$

where s is the size of the pictures taken with this camera and f is picked to be the largest value such that all points of the bounding box is still inside of the pictures taken with the virtual camera.

The transformation between the desired camera and the real camera is now a homography, and pictures from the desired camera can therefore be simulated by warping the images from the real camera.

When orientations are estimated, they are estimated relative to the new camera. This is acceptable as, if one wanted the orientation in the coordinate system of the original camera one could just apply the known inverse rotation between the two cameras, and the loss and evaluation metric and both invariant to what coordinate system is used.

We perform data augmentation similar to the data augmentations introduced in Mahendran et al. (3D pose regression using convolutional neural networks. In Proceedings of the IEEE International Conference on Computer Vision Workshops, pages 2174-2182, 2017), but adapted for our pre-processing. At test time we apply the same type of homography transformation as applied during training, but no data augmentation.

ModelNet10-SO(3) is a synthetic dataset. It is created by rendering rotated 3D models from ModelNet10 with uniformly sampled rotations. The task is to estimate the applied rotation matrix.

No preprocessing was required for these images as the object is already centred and of a reasonable size. No data augmentation was utilised, in order that comparisons between the present invention and that carried out in the original paper may be compared fairly.

UPNA head pose consists of videos with synchronized annotations of keypoints for the face in the image as well as its 3D rotation and position. The dataset has 10 people each with 11 recordings.

In a preprocessing step, we created a face bounding box for each image. After this, a small random perturbation of this bounding box was added to degrade the quality of the bounding box to be similar to what one would expect to get from a face detector. Using this artificial bounding box enables us to use the same data augmentation and preprocessing as was used for Pascal3D+.

### Network and Training

ResNet-101 was run as the backbone network. The ResNet-101 parameters are initialized from pre-trained ImageNet weights. The object’s class is encoded by an embedding layer that produces a 32-dimensional vector and which is appended to the ResNet’s activations obtained from the final average pooling layer. Three fully connected layers to this vector are applied with [512; 512; 9] nodes output at each layer. Pytorch’s implementation of SVD was used for forward and backward propagation.

The embedding and fully connected layer weights for 2 epochs were fine-tuned. SGD was used and started with a learning rate of 0.01. A batch size of 32 was used to train for 120 epochs. For Pascal3D+ this learning rate was reduced by a factor 10 at epochs 30, 60 and 90. ModelNet10-SO(3) was trained for 50 epochs and the learning rate was reduced by a factor of 10 at epochs 30, 40 and 45. For UPNA head pose, the same hyperparameters were used as for Pascal3D+, except that class embedding was not used since there are only faces in this dataset.

### Evaluation Metrics

The evaluation metrics used were based on the geodesic distance:

$$d \left(R , \hat{R}\right) = a r c c o s \left(\frac{1}{2} \left(t r \left({R}^{T} \hat{R} - 1\right)\right)\right)$$

where R and R̂ are the ground truth and estimated rotation, respectively. This metric returns an angle error that is measured in degrees. For a test set x containing tuples (x, Rₓ) of input x and its ground truth rotation Rₓ, we summarize performance on x with the median angle error and Acc@Y:

$$A c c @ Y = \frac{1}{\left|χ\right|} {\sum }_{\left(x , {R}_{x}\right) ∈ χ} \left(d \left({R}_{x} , {\hat{R}}_{x}\right) < Y\right)$$

where I̅(·) is the indicator function, R̂ₓ is the estimated rotation for input x and |·| is the cardinality of a set. To compute the overall performance on a dataset the median angle error and Acc@Y are first computed per class and then averaged across all classes. For the UPNA dataset we use the mean geodesic error angle instead of the median to allow more direct comparison with the results in Gilitschenski et al. (Deep orientation uncertainty learning based on a bingham loss. In International Conference on LearningRepresentations, 2019).

All development and hyper-parameter optimization was executed with the full training set partitioned into a training and validation set. After hyper-parameter optimization, the full training set was used for training and evaluated on the test set to get the numbers presented in the tables. For the Pascal3D+ dataset, the ImageNet validation split was used for the test set. Some samples of Pascal3D+ are labelled as “truncated”, “difficult” or “occluded”. These samples were excluded from our evaluations similar to other reported results (Liao et al., Spherical regression: Learning viewpoints, surface normals and 3d rotations on n-spheres. In Proceedings of the IEEE Conference on Computer Vision and Pattern Recognition, pages 9759-9767, 2019). This implementation detail had only a very slight effect on performance.

### Results

### Quantitative Results

Table 1 compares the performance of the method of the present invention with other high-performing approaches. Table 2 compares per class performance for some classes on Pascal3D+ with the previous state-of-the-art method (Mahendran et al., A mixed classification-regression framework for 3D pose estimation from 2D images. arXiv preprint arXiv:1805.03225, 2018). The method of the present invention significantly outperforms all the prior approaches. When the training set is augmented with the synthetic dataset from Su et al., Render for cnn: Viewpoint estimation in images using cnns trained with rendered 3d model views. In Proceedings of the IEEE International Conference on Computer Vision, pages 2686-2694, 2015), we further reduce the mean over medians angle error by approximately 1 degree.

Table 1: Performance on Pascal3D+. Results are reported for the median angle error, Acc@π/6 and Acc@π/12. The last column indicates if the training set was augmented with the synthetic dataset from [22].

| Method | MedErr | Acc@π/6 (%) | Acc@π/12 (%) | Use synth. |
|---|---|---|---|---|
| Mahendran et al. [14] | 15.38 | – | – | x |
| Pavlakos et al. [19] | 14.16 | – | – | x |
| Tulsiani and Malik [24] | 13.60 | 81.0 | – | x |
| Su et al. [22] | 11.70 | 82.0 | – | √ |
| Grabner et al. [6] | 10.90 | 83.9 | – | x |
| Prokudin et al. [20] | 10.40 | 83.9 | – | x |
| Mahendran et al. [15] | 10.10 | 85.9 | – | √ |
| Liao et al. [12] | 9.20 | 88.7 | – | √ |
| Ours | 9.11 | 90.9 | 73.4 | x |
| Ours | 8.17 | 92.8 | 77.8 | √ |

Table 2: Pascal3D+ per-class performance of our method, with or without using extra synthetic training data, compared to the competitive method Mahendran et al. [15]. The top three rows report the median angle error per class measured in degrees. The bottom three rows report Acc@π/6 measured as a percentage.

| Method | aero | bike | boat | bottle | bus | chair | dtable | sofa | train | mean |
|---|---|---|---|---|---|---|---|---|---|---|
| [15] | 8.5 | 14.8 | 20.5 | 7.0 | 3.1 | 9.3 | 11.3 | 10.2 | 5.6 | 10.1 |
| Ours w/o | 10.1 | 14.6 | 13.2 | 8.0 | 3.3 | 7.4 | 8.2 | 8.2 | 5.8 | 9.1 |
| Ours with | 6.6 | 12.5 | 11.6 | 7.7 | 3.5 | 6.6 | 11.2 | 7.4 | 5.3 | 8.2 |
| [15] | 87.0 | 81.0 | 64.0 | 96.0 | 97.0 | 92.0 | 67.0 | 97.0 | 82.0 | 85.9 |
| Ours w/o | 87.7 | 83.2 | 75.6 | 94.9 | 98.6 | 93.9 | 82.3 | 97.4 | 97.9 | 87.7 |
| Ours with | 92.9 | 88.5 | 80.7 | 95.1 | 99.0 | 98.7 | 76.5 | 99.0 | 98.0 | 92.8 |

The results shown in Table 3 also show that our method achieves state-of-the-art performance on ModelNet10-SO(3).

Table 3: Performance on ModelNet10-SO(3). *Indicates the numbers reported in the original paper, but ┤denotes the revised numbers [11] where the evaluation metric uses the distance defined in equation (5). Thus we compare the performance of our method to the latter numbers.

| Method | MedErr (deg) | Acc@ π/6 (%) | Acc@ π/12 (%) | Acc@ π/24 (%) |
|---|---|---|---|---|
| Liao et al. [12]* | 20.3 | 70.9 | 58.9 | 38.4 |
| Liao [11]┼ | 28.7 | 65.8 | 49.6 | 35.2 |
| Ours | 18.0 | 75.2 | 68.5 | 53.9 |

On the UPNA head pose dataset the algorithm of the present invention gives a mean angle error of 6.5 degrees. This is on par with the current state of the art, which quotes a performance of 6.3 degrees. However, the differences are not considered to be significant as there are only 4 persons in the test set.

### Qualitative Results

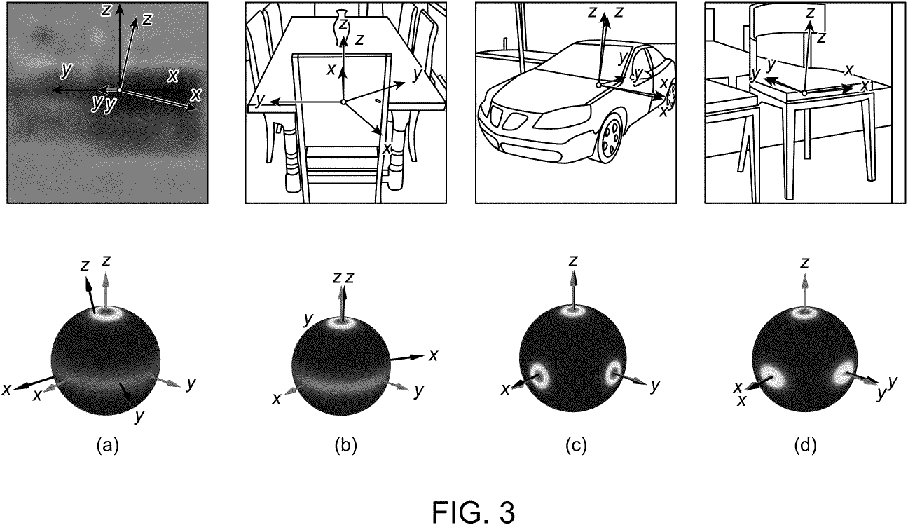

FIG. 3 displays and discusses interesting qualitative results on Pascal3D+ which highlight the probabilistic performance of the method of the present invention.

The top row displays example input images with the projected axes displaying the predicted pose (red) and labelled pose (black) of the object. The bottom row shows a visualization of the probability density function estimated by the network. The red axis shows the maximum likelihood estimate of the rotation matrix estimated from the predicted F matrix, while the axis in black corresponds to the ground truth rotation/pose. For clarity, the predicted pose has been aligned with the standard axis. Each probability plot has been scaled independently.

The examples shown have been specifically chosen to highlight our algorithm’s performance for certain cases: plots (a) and (b) are examples where model has high uncertainty for the azimuth either due to low resolution or rotation symmetry, whilst plots (c) and (d) are examples where model predicts rotations with high certainty and reasonably low errors.

### Behaviour for Classes With Rotational Symmetries

Several classes in the datasets used have rotational symmetries or effectively have rotational symmetries due to very similar appearance at several distinct viewpoints. Some examples of these classes are canoes, bathtubs, tables, desks, and bottles. The modelling of the present invention, however, is based on a unimodal distribution and it can be described how it copes with the inherent ambiguity of rotational symmetric objects.

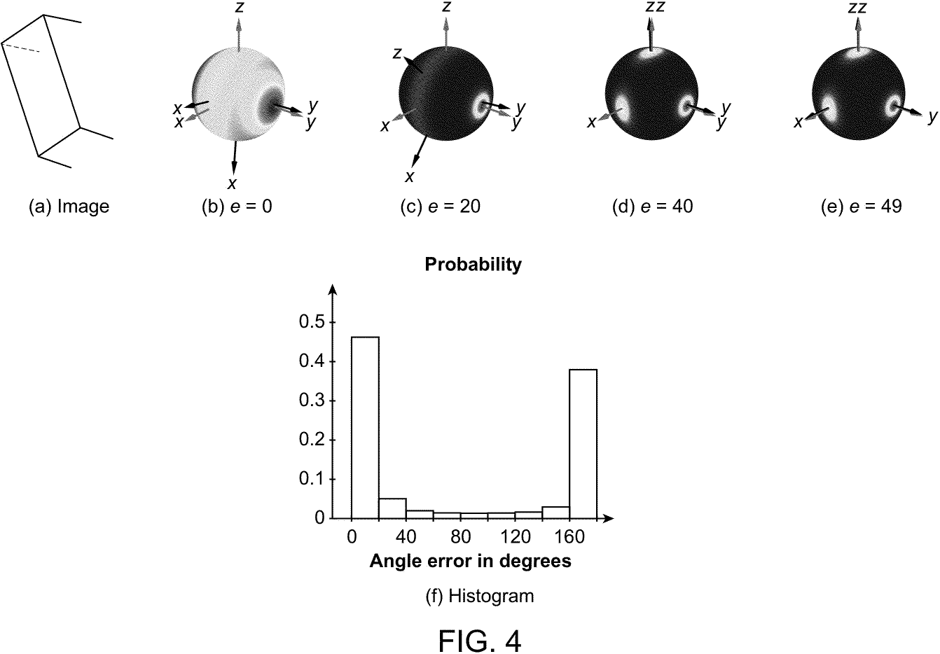

FIG. 4 shows the evolution of the estimated probability density function during training for a rotationally symmetrical object. FIG. 4(a) is a test image from the table class. FIG. 4(b) to 4(e) each display the predicted distributions for the object’s pose after e epochs of training. The mode of the distribution is shown in red and the ground truth rotation in black. FIG. 4(f) is a histogram of the test error angle for the table class after 50 epochs.

For Pascal3D+ our method performs well for the dining table class, see Table 2. However, when the synthetic data is used to augment the training data, the performance on this class drops. This may be explained by the presence of the manual labelling process introducing biases. The synthetic data added does not have these biases. Therefore, this discrepancy between the distribution of training and test set label results in the drop in performance. For ModelNet10-SO(3) the table and bathtub classes have rotational symmetries and thus these two classes have much higher median errors than the other classes, see Table 4. In FIG. 4(f) the histogram of angle errors for the table class has a “U” shape and the median is in the middle of this “U”. This histogram indicates that at test time the network predicts one of the relevant poses.

To further illuminate this point, plots (b)-(g) of FIG. 4 show the evolution of the distribution predicted during training for one specific table class test image. The axis which has no associated ambiguity is identified correctly and confidently early on in training. The other two directions are predicted to have an almost uniform distribution on the plane spanned by the ambiguous axes. This is arguably the best way for the unimodal distribution to describe the situation. In the latter stages of training the network correctly identifies the object’s full pose on the training set and uncertainty becomes small. Such behaviour should be considered as a deterioration of the network’s probabilistic modelling as it effectively randomly chose one pose from the set of plausible poses and report it is very confident about this decision. Continuing to improve the accuracy on the test set while overfitting the loss often occurs with cross-entropy training of classification networks as well. The dataset’s accuracy and loss plots, in the supplementary material section 2, show our loss may also be susceptible to this trend.

### Ablation Experiments

Ablation experiments were run on Pascal3D+ to identify the importance of the individual components of the present approach. The factors considered are data-augmentation, the class embedding and pre-processing the image via a homography. The results are shown in Table 5. Row one in Table 5 shows the performance for a very simple method which uses a standard network architecture and plain cropping without data augmentation as pre-processing. This method gets higher performance than several more complicated methods, see Table 1. This indicates that the loss we have introduced is a significant improvement by itself.

By comparing row one and two in Table 5 it can be seen that the class embedding does not seem to give any improvement for this dataset. This can also be seen by comparing row four and five. Rows one and three in Table 5 show that our warping does not provide a significant improvement by itself on Pascal3D+ compared to cropping. It is considered, however, that this warping could be advantageous in many situations and therefore should be used irrespective of these results. In theory this pre-processing should allow our method to generalize across all pinhole cameras with known intrinsic parameters and negligible radial distortion rather than for cameras with the same intrinsics as Pascal3D+.

Comparing row three with row four or comparing row one with row five show that data augmentation gives a significant improvement. This is consistent with prior work.

TABLE 5

Results of ablation experiments on Pascal3D+ for our method.

| Data aug. | Class embed | Crop | Warp× | MedErr (deg) | Acc@ π/6 (%) | Acc@ π/12 (%) |
|---|---|---|---|---|---|---|
| x | x | √ | x | 10.5 | 87.7 | 68.6 |
| x | √ | √ | x | 10.5 | 87.1 | 67.9 |
| x | √ | x | √ | 10.5 | 87.0 | 68.8 |
| √ | √ | x | √ | 9.2 | 90.9 | 73.4 |
| √ | x | x | √ | 9.0 | 90.5 | 74.1 |

### Conclusion

It can therefore be seen that the present invention provides an improved probability distribution for the recognition of object orientation in computer vison and other related areas, by use of a matrix Fisher distribution. It has been shown that a convex loss is provided when the negative log likelihood of this distribution is optimized. This provides state-of-the-art performance. Ablation studies also show the relative robustness of the approach.

1. A method of estimating an orientation of an object in an image, comprising the steps of:
calculating, for the object in the image, a probability distribution of rotation; and
estimating the orientation of the object from the calculated probability distribution;
wherein the step of calculating the probability distribution and/or the step of estimating the orientation of the object are executed by a neural network;
wherein the probability distribution is a matrix Fisher probability density function; and
wherein the step of calculating the probability distribution includes approximating a normalizing function for the matrix Fisher probability density function.

2. The method of claim 1, wherein the probability distribution is estimated about a plurality of axes.

3. The method of claim 3, wherein the rotation about each of the plurality of axes is estimated jointly.

4. The method of claim 1, wherein the matrix Fisher distribution is defined as:
$$p \left(R \vert F\right) = \frac{1}{a \left(F\right)} exp \left(t r \left({F}^{T} R\right)\right) .$$
.

5. The method of claim 4, wherein the normalizing function is defined as:
$$a \left(F\right) = {\int }_{R ∈ S O \left(3\right)} exp \left(t r \left({F}^{T} R\right)\right) d R .$$
.

6. A non-transitory computer-readable storage medium having stored thereon computer-readable instructions that, when executed by a computer, cause the computer to execute a method of estimating an orientation of an object in an image, the method comprising the steps of:
calculating, for the object in the image, a probability distribution of rotation; and
estimating the orientation of the object from the calculated probability distribution;
wherein the step of calculating the probability distribution and/or the step of estimating the orientation of the object are executed by a neural network;
wherein the probability distribution is a matrix Fisher probability density function; and
wherein the step of calculating the probability distribution includes approximating a normalizing function for the matrix Fisher probability density function.

7. The non-transitory computer-readable storage medium of claim 6, wherein the the probability distribution is estimated about a plurality of axes.

8. The non-transitory computer-readable storage medium of claim 6, wherein the rotation about each of the plurality of axes is estimated jointly.

9. The non-transitory computer-readable storage medium of claim 6, wherein the matrix Fisher distribution is defined as:
$$p \left(R \vert F\right) = \frac{1}{a \left(F\right)} exp \left(t r \left({F}^{T} R\right)\right) .$$
.

10. The non-transitory computer-readable storage medium of claim 9, wherein the normalizing function is defined as:
$$a \left(F\right) = {\int }_{R ∈ S O \left(3\right)} exp \left(t r \left({F}^{T} R\right)\right) d R .$$
.
